(19) United States
(12) Patent Application Publication
(10) Pub. No.: US 2010/0253176 A1
(43) Pub. Date: Oct. 7, 2010

(54) ELECTRICAL MACHINE HAVING A STATOR WITH RECTANGULAR AND TRAPEZOIDAL TEETH

(75) Inventors: Sigurd Ovrebo, Levanger (NO); Fredrik Idland, Trondheim (NO); Edgar Lovli, Trondheim (NO)

Correspondence Address: DENNISON, SCHULTZ & MACDONALD, 1727 KING STREET, SUITE 105, ALEXANDRIA, VA, 22314, US

(73) Assignee: SMARTMOTOR AS, Trondheim (NO)

(21) Appl. No.: 12/280,180

(22) PCT Filed: Feb. 8, 2007
(86) PCT No.: PCT/NO07/00041

§ 371 Date: Sep. 23, 2008

(30) Foreign Application Priority Data
Feb. 28, 2006 (NO) 2006 0966

(51) Int. Cl. H02K 1/16

(52) U.S. Cl. 310/216.073

(57) ABSTRACT

Arrangement at an electric machine, particularly motor, generator, or actuator, with a stator with teeth (11, 12) carrying coils (15), particularly one layer, for concentrated windings. A permanent magnetic rotor is movable relatively to the stator (11, 12). The teeth of the stator are arranged for receiving coils (15) with generally rectangular opening. Advantages are achieved if the stator teeth (11, 12) are provided to receive generally identical coils (15) closing the grooves (14, 16). The teeth (11, 12) may be alternating rectangular and converging/diverging toward the top, to provide grooves (14, 16), with parallel sides to enter the coils (15). The converging teeth (22) have preferably a shortened top (23). The grooves are preferably provided to make room for a semi magnetic groove wedge (17, 18) between adjacent teeth.

The invention relates to an arrangement at an electrical machine as stated in the introductory part of claim 1. It may be an electrical motor or generator or an actuator with an armature moving in a rectilinear or arcuated path. Such machines may be manufactured in different sizes for various purposes as stated in the examples.

### BACKGRUND

Electrical machines have traditionally been based on synchronous machines with field windings and asynchronous machines. During the last ten years the use of permanently magnetized synchronous machines (PMSM) has increased. The costs for permanent magnets have been reduced as the research and development of such machines has been intensified. A number of areas are now utilizing PMSM-machines, such as the paper industry, and offshore and marine sector. PMSM-machines have been more common also in other areas using electrical machines.

Some of the first PMSM-machines were based on the use of a standard stator from an asynchronous machine and a rotor with permanent magnets. Such a stator is shown in Assessment of torque components in brushless permanent magnet machines through numerical analysis of the magnetic field, of lonel, D. M,: Popescu, M.; McGilp, M. I.; Miller T. J. E.; Dellinger, S. J.; Industry Applications, IEEE Transactions on Volume 41, Issue 5, September-October 2005, Page 1149-1158.

Traditionally distributed windings and partly closed slots have been used in the stator of such machines. Development has been towards the use of concentrated windings. The use of concentrated windings provides several novel and interesting machine design; sectioning, increased number of poles, lower speed, direct traction etc. In addition to being of simpler design, machines of such windings have shorter end windings than machines with distributed windings. More compact machines will be possible, as the end windings do not occupy the same axial length. Common to most machines with concentrated windings is the use of partly closed slots. The drawback of this groove design is the need for feeding one and one conductor into the slot, also called fed-in winding. Partly closed slots have been used for reducing differences in reluctance and cogging moment.

Open grooves with rectangular teeth has been used for installing ready made windings. US patent application 2005035680 and 2002047425 both describes motors wherein finished windings are installed on each tooth. The disadvantage of this design is the unused void in each groove. Additionally, pulsing magnet fields occur in the stator laminate and magnets

In Japanese patent application 2002112484 the complete groove is utilized by forming the winding to be trapezoidal on one side, while being rectangular on the other side of the tooth. This has the drawback of a complicated geometry of the winding. An alternative winding design is filling the groove completely as described in EP-patent specification 1376830. The section of the winding is symmetrical to the straight tooth. In this design, partly closed grooves are used. Previously finished windings can be used, as the stator yoke is mounted after having the windings placed on the teeth. Additionally to the particular design of the winding, the assembly of such a machine is complicated.

The machine of EP-patent specification 0627805, the machine is assembled of small units. The stator consists of an array laminated units, each with two slots with a concentrated winding. The drawback of this concept is the high number of parts to be assembled.

In all PM-machines it is desirable to reduce losses due to induced currents in the rotor and stator. The losses of the stator have traditionally been reduced by using laminated sheets. Even then the magnetic properties will be uneven due to the slots. The slots of the stator will increase the magnetic coupling between stator and rotor and thus provide varying field strength in magnets, rotor yoke and stator yoke. A traditional measure for reducing such variations is partly closing of the stator slots. A number of publications is treating the improvement of this condition by different designs of the stator laminations, e.g. Ishak D., Zhu Z. Q., and Howe D:: Comparison of PM Brushless Motors, Having either all Teeth or Alternate Teeth Wound IEEE Transactions on Energy Conversion, volume PP, Issue 99, 2005, Page(s): 1-1.

Another prior art is using a rotor with split or distorted magnets. Usually a tripartition of the magnet belonging to a pole is used. The magnets are mounted by gluing with a minor angular displacement to achieve the effect of a skewed rotor. The disadvantage of both measures are the complicating and increasing of the manufacturing costs of the machine.

U.S. Pat. No. 6,661,137 (Leroy-Somer 2003) describes stator sheets with rectangular teeth. On these rectangular teeth, mounting identical coils will leave voids between the coils.

### OBJECTS

The main object of the invention is to provide an improved, simple and low cost electrical machine based on PMSM technology. The machine should be suitable for mass production, and be compact and efficient as well. The concept should be suitable for different electrical machines and in machines for different purposes.

### The Invention

The invention is described in claim 1.

A stator design with parallel rectangular slots is used, wherein ready made, compacted coils can be mounted directly. The grooves are closed with slot wedges for having a mechanical protection. The windings may be a concentrated, fractional one layer winding. The machine may be designed for an operating frequency of 150 Hz, and the coils may be wound of Litz-wire (Trademark) to increase the efficiency.

The invention can be used on rotating machines with external or internal stator. The parallel teeth and the converging teeth are designed to provide minimum cogging moment and optimized shape of the induced voltage. At an internal stator the trapezoidal teeth will be narrowest in the inner part of the slot. Compared to an internal stator with parallel teeth, this embodiment of the invention allows the use of identical coils and no conical coils will be needed.

A favourable feature of the invention is stated in claim 2. In claims 3-7 further features are described.

The idea behind this concept is that a rectangular coil may be manufactured for mounting in the stator without leaving air voids. To achieve this optimally, the stator design has to be changed. At the novel concept, differently shaped teeth have to be used in the stator. Every second tooth of the novel design is rectangular and conical respectively. The width of adjacent teeth is designed to have the voltage curve and the cogging moment optimized.

The advantage of this design is primarily a simpler manufacturing of the coils. All rectangular teeth are equal, to make all coils equal. When winding the coils, only one coil die is needed, the coils can be prepared and compacted to increase the cobber filling factor. The design of the stator makes the machine easy to manufacture in large quantities.

The next step will make the mounting of the coils easier. The filling factor of the grooves is important at designing electrical machines. By using the invention, the coils may be mass produced.

As the next consequence, the mounting of the coils is made easier. The filling factor of the grooves is important to all design of electrical machines. By using the invention it is easy to compact the coils prior to mounting. Some machines are designed for a high fundamental frequency. Such machines may have windings with a particular cross section, e.g. of the brand “Litz-Wire” to reduce the copper losses. The novel concept allows the use of rectangular wire without adaptation. The invention is also suitable for other machines, particularly with large conductor cross sections, e.g. where profiled wire may be used.

Another version of the groove design may be providing grooves with trapezoidal section in the stator. The manufacturing of the coils will then be some more complicated, because the sides (top and bottom) will not be orthogonally on the die, which has the design of the rectangular tooth. The mounting of this machine will still be simple. Trapezoidal grooves may be suitable with coarse grooves at a low diameter. The differences in length of the rectangular and the conical tooth will then be substantial. By using a rectangular groove in such a machine, the groove will be deep at the sides of a pair of grooves, demanding an increased thickness of the stator yoke.

By using the invention a better thermal transfer between stator winding and stator core compared to the machines of US patent applications 2005035680 and 2002047425, which have an air void in the groove, is achieved.

Compared to EP 0627805, the invention will provide an inexpensive machine due to the substantially lower number of parts.

The invention allows a favourable choice of number of teeth and poles to cancel moment ripples due to the reluctance moment. In this way, there is no need for a complete closure of the grooves as at traditional machines. Likewise the voltage variation is made optimal, the stator design and the choice of grooves and poles should ensure a minimizing of undesirable harmonic components in the signal.

The invention is particularly suitable for one-layer windings. At particular combinations of number of grooves and poles, a fractional one-layer windings is achieved. Fractional windings are generally known prior art of the machine design, this will reduce the head of the windings and reduce the over harmonic components of induced voltages. Different combinations of grooves and number of poles may make different cogging moments.

A normal failure at electrical machines are super-voltage and insulation damage, e.g. as a consequence of high dV/dt from the transformer. Due to local supervoltage and damaged insulation, the invention combined with concentrated coils brings advantages. Each groove of the stator will comprise only one phase, making the voltage over the insulation limited to phase-earth. The same advantage is achieved at the heads of the windings, all coils extending from adjacent grooves, no coils are overlapping. The invention also provides a larger distance from head of winding to the stator core, as the end windings are having a low overhead, which is a common measure to reduce the risk for insulation break. Further, the open grooves will make the mounting of pre-made groove insulation easier. This also applies for a shielding of the coil against the stator core.

One layer windings with concentrated coils allows sectioning the winding both electrically and physically. This will make the machines more resistant to errors and can also be run with reduced output. The degree of resistance to error is controlled by the connector configuration, as both the cantilever of the phases and the cables are having an impact.

Sectioning of the winding allows individual control over the individual coils or groups of coils, which allows the positioning of the rotor in the stator. It will be possible to read the position of the rotor in the stator, and the winding is used as a position sensor.

Further, a sectioned winding will allow sectioning of the total stator, which is valuable for larger machines, with freight and handling as limiting factors. At a damage of the stator, it will be possible to change individual sections, reducing the disruption due to errors. The machines thus will allow local repair.

The invention may be used for stators for all kinds of electrical machines, asynchronous, standard synchronous, DC, BLDC and all kinds of PMSM machines.

### EXAMPLE

The invention is described further with reference to the drawings, wherein

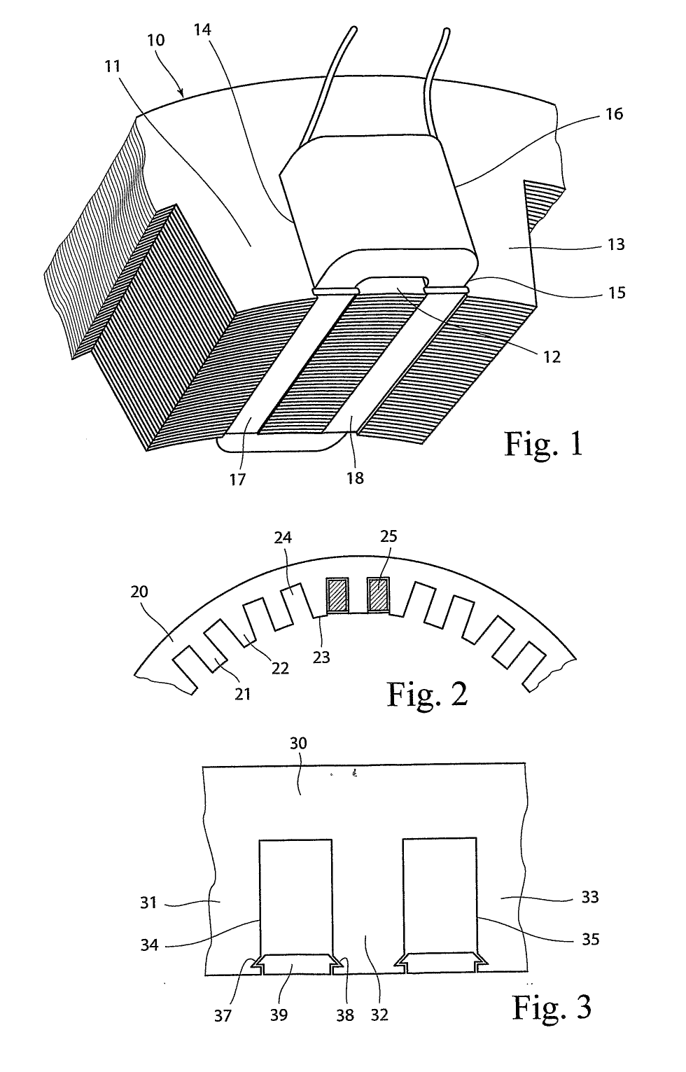

FIG. 1 shows a section of an outer stator of a first embodiment of the invention,

FIG. 2 shows a stator lamination for an external stator according to an embodiment of the invention, while

FIG. 3 shows an end view of two tooth tops with a slot wedge.

FIG. 1 shows a bundle of stator sheetings 11 with teeth 11, 12, 13 providing slots 14, 15 for mounting of a coil 16. Every second tooth 12 is parallel and a coil 16 with a uniform opening and uniform windings can be mounted. The slots of this example are closed with slot wedges 17, 18, as described with reference to FIG. 3.

FIG. 2 shows an alternative embodiment of a stator lamination 20 for preparing an external stator. The rotor of this electrical machine may have prior art design and is not shown. The stator laminations 20 have alternating parallel teeth 21 and trapezoidal teeth 22 converging outwardly with tops 23. Thus couples of parallel slots 24 for insertion of prior art rectangular coils are provided. The width of adjacent teeth should be determined to optimize the voltage curve and the cogging moment. In the example the teeth are shown with uniform top width. But this may be different, e.g. with a relationship of 0.9-1.1 to 1. The convergence of the teeth 22 are determined by the number of poles and the slot width. A coil 25 is arranged on a tooth 21.

It is also possible to provide coils with parallelogram section to optimize the slot filling further at slot floors not being perpendicular to the side of the tooth carrying the coil.

FIG. 3 shows a section of a stator lamination 30 with teeth 31, 32, 33 defining two slots 34, 35. At each tooth top 36, the limbs have V-grooves 37, 38 mating the bevelled side edges of a slot wedge 39. After sideward insertion of the slot wedge 39, this will be fixed and prevent the forcing of the coil (not shown) from the slot. The slot wedge can be of iron powder, fibreglass and glue. The sides may have grooves with alternative geometry.

The use of the slot wedge is a particular useful feature of the invention. The material of the slot wedges should be selected in regard to permeability and design of the wedge in combination provide a uniform reluctance. Normally the permeability is 5-10 times the permeability in vacuum and 100-1000 lower than for normal lamination. The slot wedge may be plain rectangular or they can be adapted. To exploit mechanisms like different magnetic saturation points in different materials is an important part of the optimizing.

The material and the design of the slot wedges should be considered to avoid undue losses due to eddy currents. Otherwise critical hotspots may occur in proximity to the wedges.

### Loss Due to Varying Flux

In the iron:

P_{Fe}˜k₁B²f+k₂B²f²+k₃B^{3/2}f^{3/2} is an example of an equation describing the losses of the iron as a function of the flux densitiy (B) and the frequency (f). The constants k₁, k₂, k₃ are determined by the properties of the material and the design of the sheet. The equation describes the losses of the sheet at sinusoidal flux. The flux density referred to can be related to a variation of the flux due to open grooves and permanent magnets. By introducing a semi magnetic groove wedge, a substantial reduction of the flux variations and the losses are reduced with the square of the changes in flux density.

### In the Magnet:

The equation P_{PM}˜k₄B² describes typical losses of a permanent magnet as a function of the flux density (B). The losses are a function of conductivity, thickness, width, flux density and frequency. In a PMSM-machine with open grooves, the flux of the magnet will vary in the magnet and eddy current losses will occur in the magnets. The flux density referred to can be related to a variation in the flux due to the use of open grooves and permanent magnets. By introducing a semi magnetic groove wedge, a substantial reduction in the flux variation is achieved, as the losses are reduced with the square of the change in flux density.

Flux density of a machine can also be related to the cogging moment of this machine. By introducing groove wedges in combination with the use of concentrated windings, the losses are reduced to an insignificant size. Prior art machines have a substantial cogging moment.

The arrangement and the attachment of the wedges has to take into account the shape of the voltage and the cogging moment. Depending on the proximity to the air gap, the wedges provide different contributions to a reduced cogging moment and harmonic. If the wedges are attached to depend on friction, the proximity to the air gap should be verified for each wedge. The need for mechanical attachment is depending on the pressure excrete from the copper on the wedge, and additional the wedge may experience a pressure from the air gap side, if an inner stator ring or similar is arranged. A solution to achieve increased mechanical strength may be incorporating of the semi magnetic material in a more sturdy material, or arranging two groove wedges, one for mechanical strength and one for smoothing the variation of reluctance.

The invention can be utilized for different purpose electrical machines, particularly for rotating machines. It can e.g. be used for propulsion systems for land or sea, i.e. for ships, cars and particular vehicles. At sea, it can be uses for control systems and winches. It can be used for water and air powered generators and at other turbines. It may also be used for various industrial applications.

The use of one layer concentrated windings provides various opportunities for incorporating redundancy in the machine. The use of open grooves provide for a simple and inexpensive manufacturing and mounting. The use of semi magnetic groove wedges provides substantial reduction of the losses of the machine.

The invention allows making the machine optimal in regard of efficiency, reliability and costs. In machines with open grooves and prior art groove wedges, pulsation magnetic fields in iron and magnets will occur as a result of different reluctance for different rotor positions. The varying reluctance is due to the discrete configuration of stator. In prior art machines, partly closes grooves are being used for limiting this effect. At the present invention groove wedges with magnetic properties are uses to equalize the difference between the magnetic properties of the groove relative to the tooth. This groove wedges are called semi magnetic. They are characterized in being partly of completely of a material with a permeability exceeding 1.

Open grooves combined with semi magnetic groove wedges are particularly suited for making the voltage shape and the cogging optimal, combined with a substantially less complicated mounting. The material of the groove wedge should typically be chosen to have the combination of the permeability and the wedge design to provide the desired equalizing of reluctance. Alternative wedge designs may be used if the wedges involve increased permeability relatively to an open groove.

The invention utilizes a preferred choice of number of teeth and poles to cancel moment ripples due to the reluctance moment. Thus, it will not be necessary to close the grooves maximally as for prior art machines. Correspondingly the shape of voltage is made optimal and the stator design and the choice of number of grooves and poles should consider the desire for minimizing undesirable harmonic components in the output.

The invention can be combined with different rotors. For PM-motors a machine with squared or sinusoidal counter induced voltage can be provided. Said machines is referred to as brushless DC-machine and permanent magnet synchronous machine. The magnets of such a machine can be mounted at the surface or submerged. The rotor yoke may be laminated or solid. In machines with high demand for efficiency, the magnets are laminated to reduce the losses.

1. Arrangement at an electric machine, particularly motor, generator, or actuator, with a stator with teeth (11, 12) carrying coils (15), particularly one layer, for concentrated windings, and a movable, particularly rotary, permanent magnetic rotor or armature, which is moved relatively to the stator (11, 12), the teeth of the stator are arranged for receiving coils (15) with generally rectangular opening, characterized in that the stator teeth (11, 12) are provided to receive generally identical coils (15) closing the grooves (14, 16).

2. Arrangement according to claim 1, characterized in that the teeth (11, 12) are alternating rectangular and converging/diverging toward the top, to provide grooves (14, 16).

3. Arrangement according to claim 2, with external stator, characterized in that the converging teeth (22) have a shortened top (23).

4. Arrangement according to claim 3, characterized in that the teeth (11, 12) have substantially equal width of the tops.

5. Arrangement according to claim 1, characterized in that the grooves are provided to make room for a semi magnetic groove wedge (39) between adjacent teeth.

6. Arrangement according to claim 5, characterized in that groove wedges (39) with a permeability equal to or above 1.0, are arranged between the teeth (31, 32).

7. Arrangement according to claim 6, characterized in that the grooves have grooves (37, 38) in the side walls to guide groove wedges (39).

8. Arrangement according to claim 1, characterized in that the coils are pressed to a shape corresponding to that of the grooves.
